(19) United States
(12) Patent Application Publication
(10) Pub. No.: US 2010/0180101 A1
(43) Pub. Date: Jul. 15, 2010

(54) Method for Executing One or More Programs on a Multi-Core Processor and Many-Core Processor

(75) Inventors: Wolfgang Trumler, Uttenreuth (DE); Sascha Uhrig, Stadtbergen (DE)

Correspondence Address: JANSSON SHUPE & MUNGER LTD., 245 MAIN STREET, RACINE, WI, 53403, US

(73) Assignee: UNIVERSITAT AUGSBURG, Augsburg (DE)

(21) Appl. No.: 12/685,416

(22) Filed: Jan. 11, 2010

(30) Foreign Application Priority Data
Jan. 13, 2009 (DE) 102009004810.3-53

(51) Int. Cl. G06F 15/76; G06F 9/06; G06F 9/44

(52) U.S. Cl. 712/30; 717/116; 712/E09.003

(57) ABSTRACT

The invention relates to a method for executing computer usable program code or a program made up of program parts on a multi-core processor (1) with a multiplicity of execution units (21, 22, 23, 24), each of which comprises a local memory (201) and at least one processing unit (202) communicatively linked to the local memory, wherein each of the execution units (21, 22, 23, 24) is connected to a communications network (30) for data exchange. One or more program parts are stored in at least some of the local memories (201) of the majority of execution units (21, 22, 23, 24). Execution of a program part is performed by the processing unit (202) of the particular execution unit (21, 22, 23, 24) that has the program part stored in its local memory (201).

### CROSS REFERENCE TO RELATED APPLICATION

This application claims priority based on German patent application DE 10 2009 004 810.3-53, filed Jan. 13, 2009.

### FIELD OF THE INVENTION

The invention relates to a method for executing a program made up of program parts on a multi-core processor, which consists of a multiplicity of execution units connected to a communications network for data exchange. The invention further relates to a computer program and also a multi-core processor of the aforementioned type.

### BACKGROUND

The way in which processors process programs is characterised in that the execution of a program requires both the program's code and also the data required for this to be available for the processor, i.e. present in the processor. If either the code or the necessary data are not available to the processor, they must be loaded from a memory that is communicatively linked to the processor, a procedure that is correspondingly time-consuming. The problem with this is that the communication link between the memory and the processor is comparatively slow.

In the case of multi-core processors with several execution units referred to as processor cores, this can result in a drop in processing power compared with a processor with only one single execution unit (single-core processor), due to the time-consuming transportation of data or codes for downloading. Moreover, redundancy may occur with a multi-core processor. This means that one and the same piece of data is simultaneously (and therefore redundantly) stored in the local memories of several execution units. The local memories are typically referred to as cache memories. This makes it necessary to carry out a consistency procedure, which keeps the data in the memories of all execution units constant. However, these procedures are very expensive and generate a high data load on the communications network connecting the execution units with one another. With just four execution units (processor cores), this can produce 50% of the total load. In the case of multi-core processors with more than eight or 16 execution units (many-core processors), a further rise in the proportion of these consistency messages is expected.

The processing power theoretically provided by multi-core processors cannot therefore be utilised in a satisfactory manner. The present invention therefore addresses the problem of specifying an improved method for executing a program made up of program parts on a multi-core processor, which enables the performance of the multi-core processor to be improved. A further problem addressed by the present invention is that of specifying a computer program that can be used to improve the performance of a multi-core processor. A further problem addressed by the invention is that of specifying a multi-core processor, which permits improved performance compared with the state-of-the-art multi-core processors.

### SUMMARY OF THE INVENTION

The invention provides a method for executing a program consisting of program parts on a microprocessor with a multiplicity of execution units. At times throughout the description, a processor core within a multi-core or many-core processor is referred to as the execution unit. Each of the execution units consists of a local memory and at least one processing unit communicatively linked to the local memory. Each of the execution units is connected to a communications network for data exchange. The communications network may be designed as a bus system or Network on a Chip (NoC). One or more program parts of the program are stored in at least some of the local memories of the majority of execution units. Execution of a program part of the program is performed by the processing unit of the particular execution unit that has the program part stored in its local memory.

In a preferred embodiment, it is desirable to transfer execution to the location, i.e. the execution unit, where the program parts are already present, rather than transporting such program parts, which each comprise a code portion and data, to an execution unit. By avoiding transporting the code and data to the execution location, not only is latency during execution of a program reduced, but the burden on the communications network is also significantly relieved. By largely foregoing the transportation of data and/or codes of one or more program parts, execution of the program by the execution unit holding the corresponding data in its local memory can continue without delay.

In one preferred embodiment, an execution context unit of one of the execution units reads out at least a part of an execution context of the program part executed on this execution unit and transfers it to another of the execution units for execution, when the program part stored on the other execution unit is needed to execute this program part. The execution context may comprise, for example, a register set including an instruction counter and one or more function parameters. The execution context unit which may be part of the processing unit of an execution unit may optionally transfer the whole execution context or parts thereof, e.g. only function parameters, to the other execution unit. The receiving execution unit, i.e. its execution context unit, transfers the received data to the processing unit located there, so that execution of the corresponding program part of the program can then take place.

It may, in particular, be envisaged that the program is produced from an object-oriented programming language, wherein objects and the program's program code belonging to a class of objects are stored on at least some of the execution units in their local memories. Programs with object-oriented languages, such as C++, C#, Java or Objective-C are translated by a compiler straight into an executable machine code or byte code. By compiling the programs, a program code is produced from the object-oriented program, which contains the executable structure of the program. An object and also a program code belonging to a class of objects represent a program part of the entire program, which runs on the multi-core processor. The method according to the invention can be used particularly well with object-oriented programming, since the data and code are closely related in the case of an object and can be correspondingly enclosed in a unit. Objects may be stored in the local memories of the multi-core processor's execution units. The execution then jumps to the execution unit when there is a method or function call; said execution unit holds the object (code and data) in the local memory concerned.

It will be understood that the method according to the invention may be used with any programming language and is not limited to object-oriented programming languages.

According to a further embodiment, the program parts at the program's run time are stored in a respective local memory of the multiplicity of execution units. The program's program parts may therefore be stored in the respective local memory at the start and/or during execution of the program.

According to a further embodiment, a program part to be stored in the local memory of a first execution unit is stored in the local memory of a second, preferably physically adjacent, execution unit, if the local memory of the first execution unit is full. In this context, “physically adjacent” means that the communication paths in the communications network between the first and second execution unit are short. “Short” in this context means that they are short in relation to time. In this case, it can be particularly envisaged that a reference to the program part in the second execution unit may, optionally, be made in the local memory of the first execution unit. In this way, short latency can be achieved during program execution.

In the case of an object-oriented programming language, the result of this is that during execution of a method call to a remote object, execution switches by sending a message to the corresponding second execution unit and the program processing continues on the remote second execution unit. The message need only convey the reference to the object, the method and the necessary parameters. The program code belonging to the object class is also advantageously stored on the second execution unit, in order to guarantee quick execution of all functions concerning this object. Further objects of the same class may preferably be produced on the second execution unit.

In accordance with a further preferred embodiment, older program parts in terms of time are removed to a memory particularly provided outside the multi-core processor, if the local memories of the execution units no longer allow storage of new programs. Such memory may be a cache memory. This process is part of a removal or swapping strategy, as only in a few cases several programs will fit completely into the local memories of execution units. A swapping of program parts can be avoided in principle, until the local memories of all execution units of the multi-core processor are full. Only then does a part of the local memory in an execution unit need to be swapped to produce a new program part. This process therefore corresponds to a traditional removal swapping to an external memory. If these program parts are accessed again in future, they must be loaded into the local memory of one of the execution units of the multi-core processor.

In a preferred embodiment of the invention, it is furthermore possible to check whether a program part can be moved from the local memory of a first execution unit into the local memory of a second execution unit, before the program part is moved into the memory provided outside the multi-core processor. The removal of program parts (particularly in traditional processors) is a time-consuming procedure, as it always involves communicating with an external memory or a cache memory. Access to the significantly slower external memories or cache memories increases the latency before the next instruction is executed, thereby reducing the program's execution speed significantly. The movement of individual program parts to other execution units circumvents this problem, so that the program's execution speed remains high. The movement (or also internal transfer) may only occur in this case if there is free local memory available on one of the execution units. The program part that has been moved is then immediately available again on this second execution unit.

According to a further preferred embodiment, a program part is moved from the local memory of a first execution unit into the local memory of a second execution unit executing the program or into the local memory of a third execution unit, which is physically close to the second execution unit. This enables execution of the program to be kept local on a few execution units, which are particularly disposed physically adjacent to one another.

A preferred embodiment of the method according to the invention facilitates the accelerated processing of several parallel programs or execution threads, as processing can always continue on one of the processing units with the information already available locally (program part code and data) without delay. Production of a new execution thread takes place on the execution unit used during run time or on an alternate execution unit to the one used during run time. By producing and using program parts on other execution units, the execution of this execution thread automatically jumps to another execution unit(s). Consequently, the execution threads are automatically distributed in the multi-core processor due to the distributed production of program parts.

In order to retain a high degree of parallelism in the production of new execution threads, a new execution thread may be created from scratch on another execution unit. When there is a large number of execution threads, improved utilization of the existing execution units can thereby be achieved. A high locality of program parts (i.e. distribution of program parts between execution units disposed physically close to one another) leads to short communication paths and reduces latency during program execution. Increased distribution of execution threads, where possible, increases the degree of parallelism and, hence, processing efficiency.

A further preferred embodiment envisages that during the execution of several execution threads on an execution unit, a first process control program is provided, particularly in the execution context unit of this execution unit, in order to allocate the available processing unit time between the execution threads. This means, advantageously, that no device is required to synchronize the execution threads, as each program part is present in the multi-core processor only once. Access may be gained via corresponding execution units. The process control program is also known as a scheduler. Traditional scheduling processes may be used, in particular, to divide up the existing processor time of the execution unit between the execution threads.

According to a further preferred embodiment, a second scheduler is provided in a respective execution unit, particularly in the execution context unit of the execution unit, to manage a multiplicity of execution requests for one and the same program part in the execution unit concerned. When several execution requests occur, the second scheduler can select the most urgent and execute this one first.

In addition, a look-up table can be provided in a respective execution unit, particularly in the execution context unit of the execution unit, according to a further preferred embodiment. This makes the destination of the transfer, i.e. the execution unit containing the program part searched for, easier to locate.

According to a further preferred embodiment, a global indirection table is provided in a main memory located outside the multi-core processor and linked communicatively to the multi-core processor, which maps virtual addresses of the program parts on the physical addresses of the respective local memories of the execution units. This embodiment is based on the knowledge that the program parts of a program are distributed between the execution units. However, the distribution of the program parts means that only the creator of a program part is initially aware of the current position of this part. If another execution thread wants to access the same program part, it must determine the address of the program part, consisting of the execution unit code and the local memory address of the program part. The global indirection table in the main memory can be used for this purpose. If a program part is searched for using its memory address, this can be answered through access to the indirection table. The advantage of such cross-reference is that the references of the program parts, which have been moved from one execution unit to the other by removal, an optimization algorithm or optimization strategy, can be updated at a central point—preferably the main memory. This avoids the time required to provide or otherwise inform all execution units of a reference to a program part, if a program part is moved.

Part of the information to be stored in the indirection table is advantageously held in the local memories of the respective execution units. A hierarchical process is thereby advantageously achieved. The information held in the local memories contains, for example, the most frequently requested program part addresses. If an entry is not found in the execution unit's own sub-indirection table, the entry in the global indirection table is determined in the main memory.

In accordance with a further preferred embodiment, a pointer routing process is used to locate a program part, in which an execution request relating to a program part being searched for is forwarded from one execution unit to another, if the program part being searched for is not stored in the forwarding execution unit and the forwarding execution unit knows the other execution unit with the program part being searched for. This means that the global indirection table does not have to be addressed with each remote access (i.e. access to a program part stored on another execution unit) to a program part. In addition, no other execution unit need be informed of the new memory location of the program part when a program part is moved. This is automatically updated by the first call to the remote program part.

An additional preferred embodiment includes a computer program product with a computer usable medium having computer usable program code for executing the process described, when the program runs on a computer with a multi-core processor. The computer usable program code may be realized on a computer program product, which takes the form of a diskette, a CD-ROM, a DVD, a USB memory stick or similar media or memory. The computer usable program code may also be realized in the form of a data signal that can be transmitted or has been transmitted across a network.

A further preferred embodiment creates a multi-core processor with a multiplicity of execution units, each of which comprises a local memory for storing one or more program parts of the program and at least one processing unit communicatively linked to the local memory. Each of the execution units is connected to a communications network for data exchange. The multi-core processor is controlled in such a way that a computer usable program code is executed by the processing unit of those execution units, which has the program part stored in its local memory.

The multi-core processor according to the invention offers the same advantages as were described earlier in connection with the process according to the invention.

A multi-core processor according to the invention is particularly characterised by the fact that an execution context unit of one of the execution units is designed to read out at least part of an execution context of the program part executed on this execution unit and transfer it to another of the execution units for execution, if the computer usable program code stored on the other execution unit is needed to execute this program code. The execution context unit may be realized by software, so that the process according to the invention can be executed on a traditional multi-core processor. The execution context unit may preferably be provided as hardware, so that the multi-core processor's performance can be optimally increased. The execution context may particularly consist of a register set, including an instruction counter and a function parameter.

Moreover, the multi-core processor according to the invention exhibits further means of implementing the process described above.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Accordingly, discussion of the features and advantages throughout this specification may, but does not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

Features and advantages of the present invention will become more fully apparent from the following description, exemplary embodiments and appended claims.

### BRIEF DESCRIPTION OF THE DRAWINGS

In order that the advantages of the invention will be readily understood, a more detailed description of the invention briefly described above will be rendered by reference to specific preferred embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 shows a schematic representation of a multi-core processor according to the invention.

FIG. 2 shows a schematic representation of a single execution unit of a multi-core processor according to the invention.

FIG. 3A shows a call path of program parts of a first execution thread.

FIG. 3B shows a schematic representation of the first execution thread executed in the multi-core processor of FIG. 1.

FIG. 4A shows a call path of program parts of a second execution thread.

FIG. 4B shows a schematic representation of the first and second execution thread executed in the multi-core processor of FIG. 1.

FIG. 5 shows a further exemplary embodiment of a multi-core processor according to the invention with heterogeneous architecture.

### DETAILED DESCRIPTION

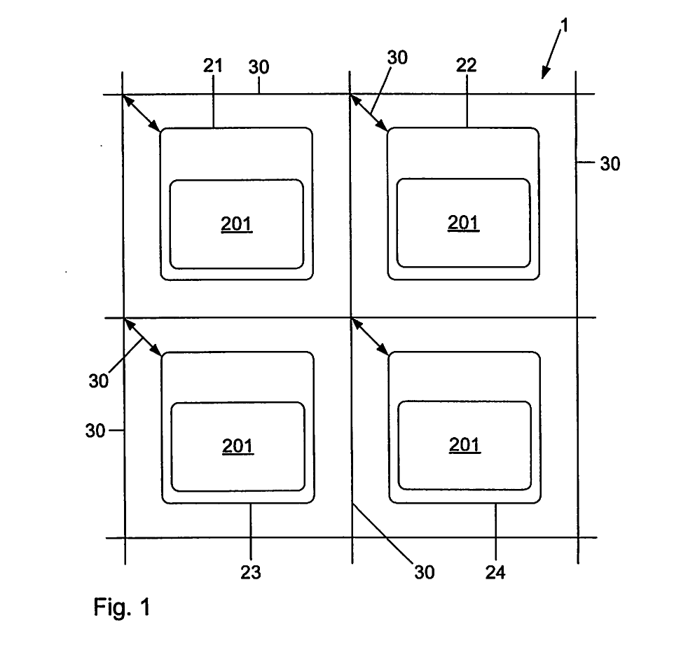

FIG. 1 shows a schematic representation of a multi-core processor 1 according to the invention, such as can be used to implement the process according to the invention. By way of example, the multi-core processor 1 has four execution units 21, 22, 23, 24. An execution unit represents a process core within the multi-core processor 1. Each of the execution units 21, 22, 23, 24 is linked to a communications network 30, which may be realized in the form of a bus system or Network on a Chip (NoC). The communications network 30 is designed in the form of a grid in FIG. 1 based on the matrix configuration of the execution units 21, 22, 23, 24, so that physically adjacent execution units can communicate with each other in a quasi-direct manner. The structure of the multi-core processor 1 thereby corresponds to the known structure of multi-core or many-core processors with a greater number of processor cores. The number of execution units provided in multi-core processor 1, their spatial configuration and also the nature and design of the communications network 30 are of secondary importance to the implementation of the process according to the invention and will not therefore be dealt with in greater detail below.

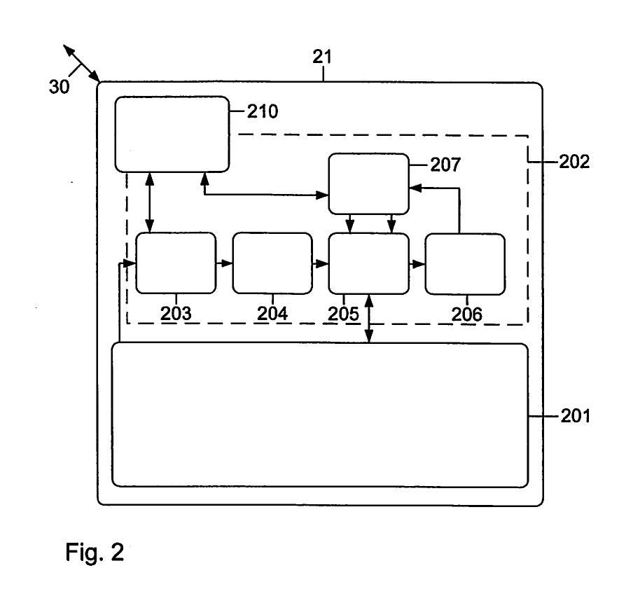

Characteristic of an execution unit 21, 22, 23, 24 of a multi-core processor 1 according to the invention is the existing local memory 201 depicted in FIG. 1. The local memory 201 may take the shape of a cache memory. Apart from the local memory 201, each of the execution units 21, 22, 23, 24 has further elements, which are explained in greater detail below the help of the schema in FIG. 2.

Apart from the memory 201, the execution unit 21 illustrated by way of example in FIG. 2 exhibits in a known manner a processing unit 202. The processing unit 202 is referred to as a processor pipeline and exhibits, also in a known manner, a fetch 203, a decoder 204, an execution unit of the processing unit 205 (Exe) and also a write-back unit 206. The execution unit 205 is linked to a register 207 and to the local memory 201. Data contained in the local memory 201 can also be supplied by the latter to the fetch 203. A so-called execution context unit 210 is provided as a further unit alongside the processing unit or as an element of the processing unit 202. The execution context unit 210 is communicatively linked to the fetch 203 and also to the register 207. The register 207 may, in addition, receive data from the write-back mechanism 106. The execution unit 21 is connected via the execution context unit 210 to the communications network 30.

The process according to the invention for executing a program consisting of program parts on the multi-core processor 1 with the execution units described is based not on transporting program parts (comprising code and data) to an execution unit of the multi-core processor, but on moving execution to the execution unit that contains the program part to be executed in its local memory. Avoiding the transportation of program parts to the execution location in this way not only reduces latency in the program execution, but relieves the burden on the communications network.

The problem addressed by the execution context unit 210 is that of reading out the execution context of the execution unit concerned, insofar as the program parts required in order to process the program are not contained in the local memory 201 of this execution unit. The execution context unit 210 transfers the execution context, e.g. a complete register set including instruction counter and/or only function parameters to the execution unit of the multi-core processor 1, which has stored the corresponding program parts. The execution context unit 210 of the receiving execution unit received transports the data conveyed to the local processing unit 202 and then initiates execution of the corresponding program part.

The process can be effectively used in conjunction with the paradigm of object-oriented programming, since object data and code are related to one another and may be packaged accordingly as a unit. In particular, objects can be stored in a multi-core processor in the local memories of the individual execution units, wherein execution of the program “jumps” to the execution unit holding the object (i.e. code and data) in its local memory when there is a method call. Although the invention's use is not limited to object-oriented programming languages, this is referred to below for a simpler description of the relationships, wherein an object corresponds to a program part of a program.

The objects of a program, comprising code and data, are stored during execution time in the local memories 201 of the individual execution units 21, 22, 23, 24. As long as there is still memory available on one of the execution units 21, 22, 23, 24, new objects can be created locally. If the local memory of an execution unit 21, 22, 23, 24 is used up, new objects are created on other execution units and a reference to the corresponding execution unit is stored. If a method call is then executed to a remote object, the execution switches by sending a message to the execution unit holding the object and the program processing is continued on this execution unit. The message must also include reference to the object, the method and also the necessary parameters.

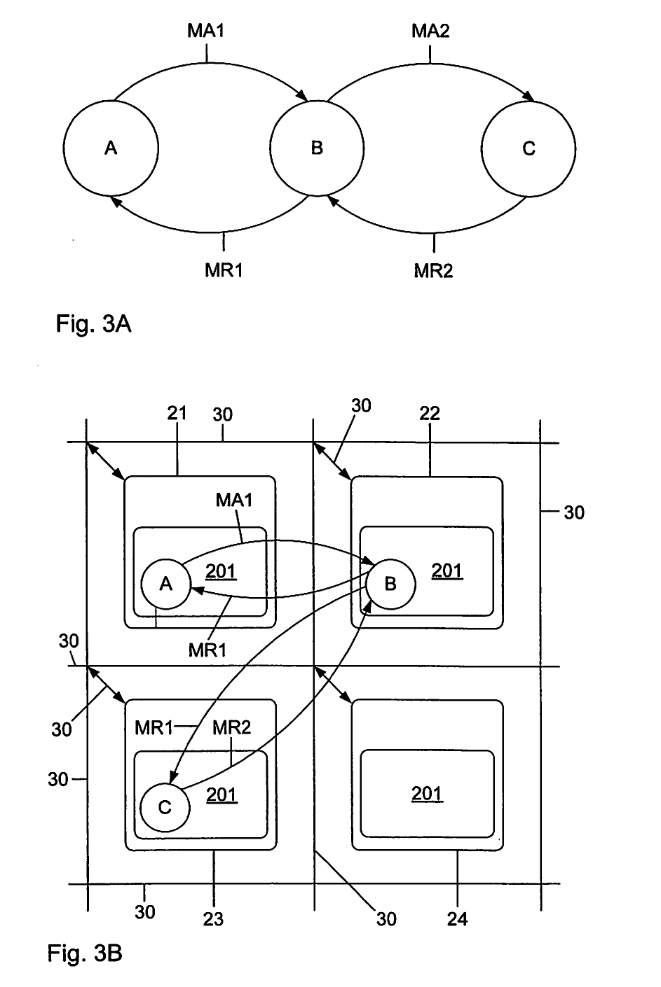

A preferred embodiment is shown below based on the structure illustrated in FIGS. 3A and 3B. execution of the program switches between different execution units. The following code sample provides one example of the steps and features of the present invention as claimed herein and specifically related to switching between different execution units.

| | |
|---|---|
| 1 | /* |
| 2 | * Program execution begins with class A and class B being |
| | called up |
| 3 | */ |
| 4 | classClassA { |
| 5 | // Produce object of class B |
| 6 | ClassB objectB = new ClassB ( ); |

7

| | |
|---|---|
| 8 | void main ( ) { |

| | |
|---|---|
| 9 | // Processing begins here. Class A produces an entity, |
| | which |
| 10 | // calls up an internal method in which class B is in turn |
| | called up |
| 11 | ClassA objectA = new ClassA ( ); |
| 12 | objectA.callB ( ); |

| | |
|---|---|
| 13 | } |

14

| | |
|---|---|
| 15 | void callB ( ) { |

| | |
|---|---|
| 16 | // Call up class B method |
| 17 | objectB.method ( ); |

| | |
|---|---|
| 18 | } |

| | |
|---|---|
| 19 | } // End of class A |
| 20 | |
| 21 | /* |

| | |
|---|---|
| 22 | * Class B is called up by class A and calls class C up itself |
| 23 | */ |

| | |
|---|---|
| 24 | class ClassB { |

| | |
|---|---|
| 25 | // Create class C entity |
| 26 | ClassC objectC = new ClassC ( ); |

27

| | |
|---|---|
| 28 | void Class B ( ) { |
| 29 | } |
| 30 | // Class C method called up here |
| 31 | void method1( ) { |

| | |
|---|---|
| 32 | objectC.method2( ); |

| | |
|---|---|
| 33 | } |

| | |
|---|---|
| 34 | } // End of class B |
| 35 | |
| 36 | /* |
| 37 | *Class C is called up by class B |
| 38 | */ |
| 39 | class ClassC( ) |
| 40 | |

| | |
|---|---|
| 41 | void Class C( ) { |
| 42 | } |

43

| | |
|---|---|
| 44 | void method2( ) { |
| 45 | } |

| | |
|---|---|
| 46 | } // End of class C |

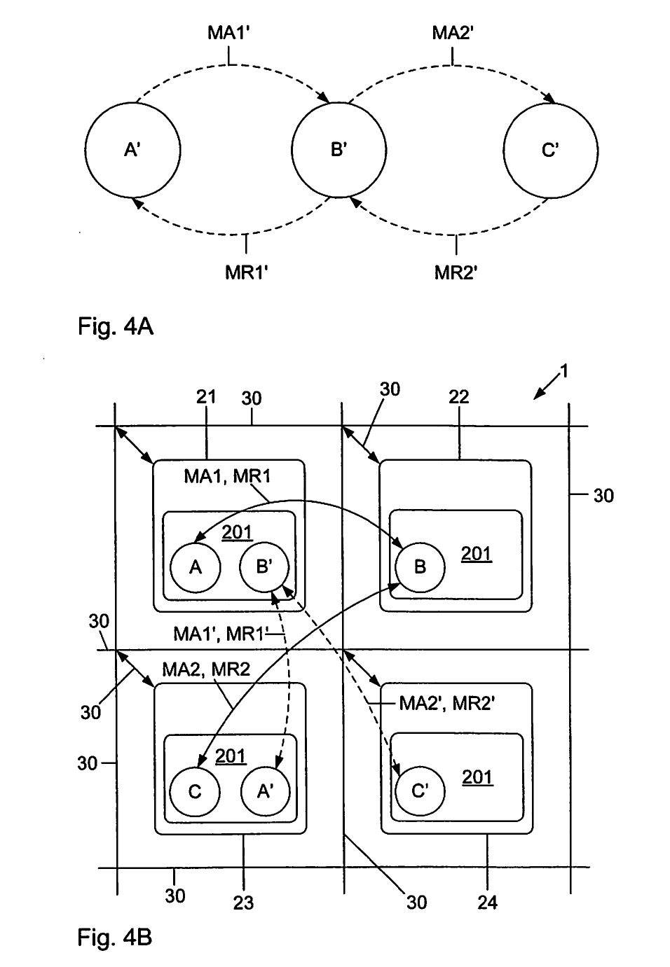

The Java program shown consists of three classes. The program's main method is defined in “ClassA”, in which the program execution begins. ClassA defines an entity of ClassB (line 6), in which the method “method1” is then called up (line 17). The class “ClassB” in turn defines an entity of the class “ClassC” (line 26) and calls up the method “method2” (line 32). The objects, which represent class entities, are designated A, B and C in the program and also in FIGS. 3 and 4.

The call path between the objects “objectA”, “objectB”, “objectC” (in short: A, B, C) of the above program is illustrated in FIG. 3A. The method “method1” of object B is called up from object A (method call MA 1). Object B in turn calls via the method call MA2 the method “method2” of object C. Once the method “method2” of object C has been terminated, the execution returns to object B (method return MR2). When the processing of the method “method1” is completed there, the execution finally returns to object A (method return MR1).

Assuming that the objects A, B, C are distributed between the existing execution units 21, 22 and 23, as illustrated in FIG. 3B, the execution sequence 1^{st} to 4^{th} results for the process, which are each depicted alongside the method calls MA1, MA2 or method returns MR1, MR2. Execution of the program begins with object A on the execution unit 21. When the method “method1” on object B (1st) is called, execution switches to execution unit 22. From there, the method “method2” of object C is called up (2^{nd}) and execution continues on execution unit 23. Once the method of object C has been executed, execution returns to execution unit 22 (3^{rd}) and once the method of object B has been processed, finally to execution unit 21 (4^{th}).

Now referring to FIGS. 4A and 4B, if the same program is processed with different objects (for example, a second execution thread), the same call path results as for the first execution thread. The associated objects are designated A′, B′ and C′ to distinguish them. FIG. 4A shows the associated call path, which path corresponds to that shown in FIG. 3A.

One possible preferred configuration is depicted in FIG. 4B, occurring if the two execution threads are processed at the same time on the execution units 21, 22, 23, 24 of the multi-core processor 1. In this case it is assumed that the objects A, B, C, A′, B′ and C′, as represented in FIG. 4B, have been created on different execution units during run time. To provide a better overview, the method calls MA1, MA2, MA1′, MA2′ and the method returns MR1, MR2, MR1′, MR2′ are each represented simply with an arrow. FIG. 4B shows how the execution threads of different programs jump between the execution units 21, 22, 23, 24. As can easily be seen, especially from FIG. 4B, parallel processing of the execution threads can take place. If it is assumed that the objects A and A′ are initiated in the execution units at the same time, the execution unit 21 can process the object B′ called up by the execution unit 23 immediately after the method call of object B, etc.

At the start of the program and during program execution new objects must be created. As has already become clear from the description, objects can be created on one of the local memories 201 of the current execution unit 21, 22, 23, 24 until its capacity is used up. Further objects can then be created in a local memory 201 of another execution unit. In this case, the new objects can be created on the closest possible execution unit, depending on the optimization strategy, so that the communication paths across the communications network 30 for transmission of the execution are kept as short as possible. In this way, latency during execution can be kept to a minimum.

The production of new execution threads can be achieved in several ways. The simplest implementation envisages the production of a new execution thread on the current execution unit. By producing and using objects on other execution units, execution of this execution thread jumps automatically to the other execution units. Consequently, the threads would be automatically distributed in the multi-core processor based on the distributed production of objects. In order to retain a higher degree of parallelism in the production of new execution threads, a new execution thread may be created from scratch on another execution unit. This would lead to an improvement in the use of the available execution units, particularly where there is a greater number of execution threads. A high locality of objects leads to short communication paths, thereby reducing the latency in program execution. A good distribution of execution threads increases the degree of parallelism.

In the event that several execution threads have to be executed on one execution unit, scheduling procedures may be used to allocate the execution unit's existing processing time between the execution threads. The advantage when executing multiple execution threads is that no device is needed to synchronize the threads. Because each object is present in the multi-core processor only once and access to it can only take place via the respective execution unit, exclusive access of an execution thread to any object is guaranteed. Consequently, no critical competitions can occur.

A further advantage emerges in the case of the synchronization of execution threads by objects. If an execution thread wants to gain access to a program part protected by a synchronization object, the program execution switches to the execution unit on which the method for obtaining access can be executed. If access is possible, the program execution may be continued and the execution thread jumps back again. If access is not possible, the execution thread on the execution unit on which the synchronization object lies is blocked. Consequently, the status of the synchronization object does not have to be constantly transferred back and forth between different execution units. Instead, the execution threads competing for access to the protected zone encounter one another at the execution unit on which the synchronization unit lies. The greater the number of execution threads to be synchronized by this sort of synchronisation object, the more efficiently the process works compared with the traditional arrangement of a multi-core processor. IN a traditional arrangement of multi-core processors, the synchronization object in each case has to be transferred to the execution units. Such configuration interposes latency, increase in execution times and other types of potential delays.

In traditional processors, the swapping of data and code is a time-consuming process, as it requires communication with the next cache hierarchy level or a main memory, which is linked to the multi-core processor. Access to the significantly slower memory increases latency until the next instruction is executed and thereby reduces a program's execution speed considerably. When using the process according to the invention, an internal swapping strategy may be used before the final swapping has to be made into the main memory or a higher cache hierarchy level. The basic principle in this case is the same as when new objects or execution threads are produced. As long as there are memory locations available on one of the execution units, objects can be moved to other execution units, where they are then immediately usable.

The execution speed of programs depends crucially on whether the required objects are located in the local memory 201 of execution units 21, 22, 23, 24. Since objects can be created on other execution units too, performance losses may occur in the case of a loop, if methods of a remote object are called up over several cycles. Execution must then be moved within a limited zone, very often between several execution units. The distribution of objects can be optimized, in order to move objects to the execution location or at least close to it. If it emerges during execution of a method that certain objects are very frequently addressed by an execution unit, these objects can be transferred to the execution unit making the call, so that such execution is kept local.

If the objects required cannot all be moved to an execution unit, it is expedient for the data concerned to be moved as close as possible to the executing execution unit, in order to minimize communication paths and thereby reduce execution latency.

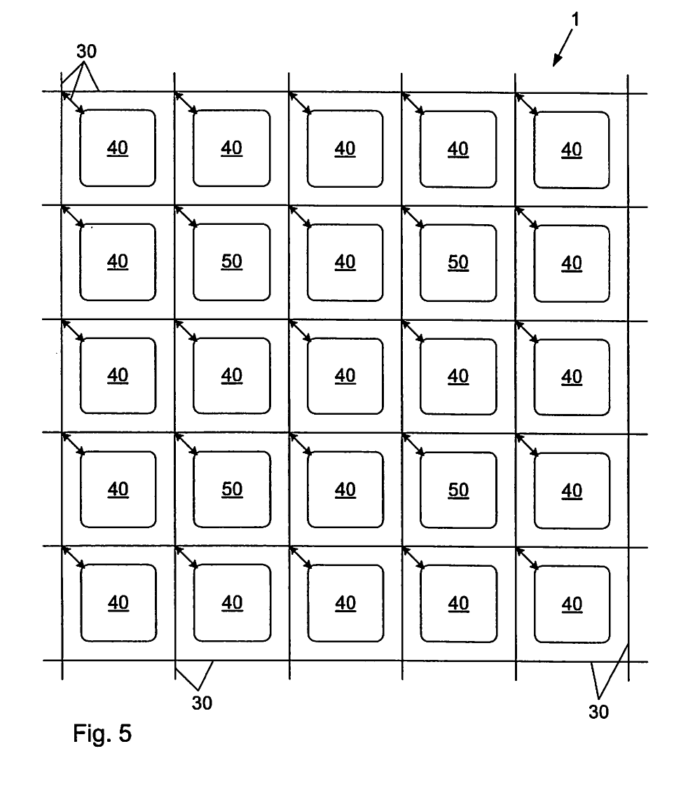

The locally available memory limits the execution speed of an execution unit. If objects other than the locally available objects are required, transfers must be made to create space for the required objects. For memory-intensive programs, there is a possibility of creating a heterogeneous architecture in the multi-core processor, which has additional memory units 50 alongside the execution units 40, into which the objects can be very quickly moved. These objects must be moved back again into one of the execution units 40 for execution. FIG. 5 shows a preferred embodiment using heterogeneous architecture of a multi-core processor 1. If a memory unit 50 is installed in a vertical and horizontal direction after each execution unit 40, each execution unit has access to at least two adjacent memory units 50, into which objects can be moved very quickly. The additional memory on the processor means that removal of objects into the main memory can be avoided for a longer period of time, which results in increased execution speed.

The advantage of heterogeneous architecture is that an execution unit other than the one that has swapped an object can also store the swapped object quickly. Adjacent execution units in particular can exchange objects very quickly, due to the short communication paths. Because only one execution thread in each case can work on an object at the same time, no additional consistency processes are needed for the memory units.

For special applications or processor variants, other configurations are also conceivable. For example, in the case of applications with a high data throughput, it may be advisable for several memory units to be placed at the periphery of the processor. Placement in this manner buffers the data transfer between the main memory and execution units towards the centre of the processor via several cache stages, Such preferred configuration will speed up the application processing.

One effect when using the process according to the invention is that the objects of a program can be distributed among the execution units. However, the distribution of the objects means that only the creator is initially aware of the object's current position. If another execution thread wants to access the same object, it must request the object address, consisting of the code for the execution unit and the object's local memory address.

A global indirection table in a main memory, which is linked to the multi-core processor, may be used for improving processing according to the invention. The global indirection table maps the virtual addresses of objects on the physical addresses of the execution unit and the objects in the local memory. If an object is searched for using its memory address, this can be answered by accessing the global indirection table. In order to speed up the address computation procedure, a hierarchical process can be used. Smaller tables on the multi-core processor store the most commonly requested object addresses. If an entry is not found in the processor's own indirection table, the entry is established from the global indirection table in the main memory.

The localization of objects may be further optimized by a pointer routing process. In pointer routing, an execution unit A temporarily saves the addresses of its known objects, including those that are disposed on other execution units. If an object is moved from another execution unit B to a further execution unit C, the execution unit A does not notice this and therefore holds the wrong pointer. Next time the execution unit A calls up a method of the moved object, execution unit B forwards the execution request to an execution unit C, where the execution then finally takes place. Through the direct acknowledgment following execution by execution unit C to execution unit A, the address list held in execution unit A is updated. Subsequent calls to the object can now be transmitted straight to the execution unit C.

This means that the global indirection table does not have to be addressed with each remote access to an object. Furthermore, when an object is moved, no other execution unit need be informed of the object's new address. The new address is automatically updated by calling up a method on the remote object for the first time.

The increase in performance achieved through the process according to the invention is due, among other things, to the fact that the execution of the execution threads takes place on the execution units with smaller latency than in traditional processes, in which code and data have to be transferred to the corresponding execution units. Apart from the reduction in latency during execution, an improved use of the local memory is also possible, as new objects can be created in the local memory on other execution units. The precise degree to which performance is increased depends heavily on the circumstances of each case.

A processing example will illustrate a comparison between a traditional process and the process in the invention. A method call in which the object and data are not present in the local memory of the current execution unit is taken as an example.

### Traditional Process

If a method call is executed on an execution unit, a cache miss occurs. The execution unit makes a request for the required data to be sent. It is assumed that the data is located in a local memory of another execution unit and can be transferred from there. If the data is in the main memory, the process would last considerably longer, as the main memory normally has a slower clock speed than a cache memory on a processor.

All commands (requests and responses) are sent in the form of messages preceded by a corresponding 1 byte code word. The request contains the address of the object data required to execute the method. The response contains a 64 byte cache line, which contains at least the start of the object's method. The request requires 5 bytes (code: 1 byte; address: 4 bytes) and the response 65 bytes (code: 1 byte; cache line: 64 bytes). This means that at least 70 bytes must be transferred in the traditional process. If the code is also needed in addition to the data (as assumed above), at least 70 more bytes in code must be transferred between the execution units. The 140 bytes therefore represent the minimum number of bytes that must be transferred in the traditional case.

### Process According to the Invention

In the process according to the invention, execution of the program is transferred to another execution unit. This requires a context pointer (CTX), the address of the execution unit (in X, Y position), the address of the object, the method code and parameters to be transferred. It is assumed that three parameters on average are sent in the case of a method call. For the return of the execution and the result, the context pointer, address of the execution unit and result must be transmitted. The transfer of the execution requires 25 bytes (code: 1 byte; CTX: 4 bytes; X: 1 byte; Y: 1 byte; object: 4 bytes; method: 2 bytes; three parameters: 12 bytes). The return of the execution requires 11 bytes (code: 1 byte; CTX: 4 bytes; X: 1 byte; Y: 1 byte; result: 4 bytes). In the case according to the invention, only 25 bytes on average must therefore be transmitted to switch execution to another execution unit and 11 bytes to transfer the execution back, insofar as a result has to be transmitted. If no result is expected, only 7 bytes are required to return the execution, giving a total of 32 bytes.

As the comparison shows, this produces a 74% lower load on the communication medium, if the optimum case is assumed for the traditional process and the normal case for the process according to the invention. If the method should comprise more than a 64 byte code, it must be possible for further cache lines to be fetched, with an additional load on the communication medium, which is not necessary in the case of the present invention. The smaller number of bytes required to transfer execution according to the preferred process of the invention also means a shorter latency before execution can continue.

The process according to the invention therefore not only reduces latency during the execution of programs, but additionally relieves the burden on the communication medium. The precise extent of the increased performance depends on the specific application concerned.

Many of the functional units described in this specification have been labeled as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically, comprise the module and achieve the stated purpose for the module.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The method, apparatus and computer code of the present invention may be performed by a computer program. The computer program can exist in a variety of forms both active and inactive. For example, the computer program can exist as software possessing program instructions or statements in source code, object code, executable code or other formats; firmware program(s); or hardware description language (HDL) files. Any of the above can be embodied on a computer readable medium, which include storage devices and signals, in compressed or uncompressed form. Such computer readable storage devices include conventional computer RAM (random access memory), ROM (read only memory), EPROM (erasable, programmable ROM), EEPROM (electrically erasable, programmable ROM), and magnetic or optical disks or tapes. Computer readable signals, whether modulated using a carrier or not, can include heartbeat data packages, error data packages, test data packages and the like. It will be understood by those skilled in the art that a computer system hosting or running the computer program can be configured to access a variety of signals, including but not limited to signals downloaded through the Internet or other networks. Such may include distribution of executable software program(s) over a network, distribution of computer programs on a CD ROM or via Internet download and the like.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer program may take any form capable of generating a signal, causing a signal to be generated, or causing execution of a program of machine-readable instructions on a digital processing apparatus. A computer program may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the forgoing description, numerous specific details are provided, such as examples of programming, software modules, user selections, network transactions, database queries, database structures, hardware modules, hardware circuits, hardware chips, etc., to provide a thorough understanding of embodiments of the invention. One skilled in the art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described preferred embodiments are to be considered in all respects only as illustrative and not restrictive. In addition, while specific component values have been shown for ease of illustration and description, it should be understood that a variety of combinations of values is possible and contemplated by the present invention. Further, while specific connections have been used and shown for ease of description, it should also be understood that a variety of connection points are possible and may vary depending on the specifics of the application and circuit used. The scope of the invention is, therefore, indicated by the appended claims rather than by the foregoing description. All changes which come within the meaning and range of equivalency of the claims are to be embraced within their scope.

What is claimed is:

1. A method for executing a program made up of program parts on a multi-core processor (1) with a multiplicity of execution units (21, 22, 23, 24), each of which comprises a local memory and at least one processing unit communicatively linked to the local memory (201), wherein each of the execution units is connected to a communications network for data exchange, wherein:
one or more program parts of the program are stored into at least some of the local memories of the multiplicity of execution units (21, 22, 23, 24); and
the execution of a respective program part of the program is performed by the processing unit of the respective execution unit, which has the program part stored in its local memory.

2. The method of claim 1 in which an execution context unit (210) of one of the execution units (21, 22, 23, 24) reads out at least a part of an execution context, particularly a register set including an instruction counter and function parameters, of the program part executed on the one execution unit (21, 22, 23, 24) and transfers it to another of the execution units (21, 22, 23, 24) for execution, when the program part stored on the other execution unit (21, 22, 23, 24) is needed to execute the program part.

3. The method according to claim 1 in which the program is produced from an object-oriented programming language, wherein objects and the program's program code belonging to a class of objects are stored on at least one of the execution units (21, 22, 23, 24) in their local memories (201).

4. The method according to claim 1 in which the program parts at the program's run time are stored in a respective local memory (201) of the multiplicity of execution units (21, 22, 23, 24).

5. The method according to claim 1 in which a program part to be stored in the local memory (201) of a first execution unit (21, 22, 23, 24) is stored in the local memory (201) of a second, preferably physically adjacent, execution unit (21, 22, 23, 24), if the local memory (201) of the first execution unit (21, 22, 23, 24) is full.

6. The method according to claim 5 in which a reference to the program part in the second execution unit (21, 22, 23, 24) may optionally be made in the local memory (201) of the first execution unit (21, 22, 23, 24).

7. The method according to claim 5 in which older program parts in terms of time are removed to a memory particularly provided outside the multi-core processor (1) if the local memories (201) of the execution units (21, 22, 23, 24) no longer allow storage of new programs.

8. The method according to claim 7 in which it is checked whether a program part can be moved from the local memory (201) of a first execution unit (21, 22, 23, 24) into the local memory (201) of a second execution unit (21, 22, 23, 24), before the program part is moved into the memory provided outside the multi-core processor.

9. The method according to claim 7 wherein the memory particularly provided outside the multi-core processor (1) is a cache memory.

10. The method according to claim 1 in which a program part is moved from the local memory (201) of a first execution unit (21, 22, 23, 24) into the local memory (201) of a second one executing the program or into the local memory (201) of a third execution unit (21, 22, 23 24), which is physically close to the second execution unit (21, 22, 23, 24).

11. The method according to claim 1 in which production of a new execution thread takes place on the execution unit (21, 22, 23, 24) used during run time or a different execution unit (21, 22, 23, 24) to this one.

12. The method according to claim 11 in which during execution of several execution threads on an execution unit (21, 22, 23, 24), a first process control program is provided, particularly in the execution context unit (210) of this execution unit (21, 22, 23, 24), in order to allocate the available processing unit (202) time between the execution threads.

13. The method according to claim 1 in which a second scheduler is provided in a respective execution unit (21, 22, 23, 24), particularly in the execution context unit (210) of the execution unit (21, 22, 23, 24), to manage a multiplicity of execution requests for one and the same program part in the execution unit (21, 22, 23, 24) concerned.

14. The method according to claim 1 in which a look-up table is provided in a respective execution unit (21, 22, 23, 24), particularly in the execution context unit (210) of the execution unit (21, 22, 23, 24).

15. The method according to claim 1 in which a global indirection table is provided in a main memory located outside the multi-core processor (1) and linked communicatively to said multi-core processor (1), which maps virtual addresses of the program parts on the physical addresses of the respective local memories (201) of the execution units (21, 22, 23, 24).

16. The method according to claim 15 in which part of the information to be stored in the indirection table is held in the local memories (201) of the respective execution units (21, 22, 23, 24).

17. The method according to claim 1 in which a pointer routing process is used to locate a program part, in which an execution request relating to a program part being searched for is forwarded from one execution unit (21, 22, 23, 24) to another execution unit (21, 22, 23, 24), if the program part being searched for is not stored in the forwarding execution unit (21, 22, 23, 24) and the forwarding execution unit (21, 22, 23, 24) knows the other execution unit (21, 22, 23, 24) with the program part being searched for.

18. A computer program product comprising computer usable medium having computer usable program code for executing the process described according to claim 1, when the computer usable program code runs on a computer with a multi-core processor.

19. A multi-core processor (1) with multiple execution units (21, 22, 23, 24), each of said execution units comprises a local memory (201) for storing one or more program parts of the program and at least one processing unit (202) communicatively linked to the local memory, wherein each of the execution units (21, 22, 23, 24) is connected to a communications network (30) for data exchange and the multi-core processor (1) is controlled in such a way that a program part of the program is executed by the processing unit of the execution unit (21, 22, 23, 24), which has the program part stored in its local memory (201).

20. The multi-core processor according to claim 19 in which an execution context unit (210) of one of the execution units (21, 22, 23, 24) is designed to read out at least part of an execution context, particularly a register set including an instruction counter and a function parameter, of the program part executed on the one execution unit (21, 22, 23, 24) and to transfer it to another of the execution units (21, 22, 23, 24), if the program part stored on the other execution unit (21, 22, 23, 24) is needed in order to execute this program part.
